(19) United States
(12) Patent Application Publication
(10) Pub. No.: US 2002/0076004 A1
(43) Pub. Date: Jun. 20, 2002

(54) System using a personal digital assistant to redirect a voice message to a telephone

(76) Inventors: Allan E. Brockenbrough, S. Hamilton, MA (US); Larry E. Ayres, North Andover, MA (US); Carlos Colon, Londonderry, NH (US)

Correspondence Address: STAAS & HALSEY LLP, 700 11TH STREET, NW, SUITE 500, WASHINGTON, DC, 20001, US

(21) Appl. No.: 09/736,165

(22) Filed: Dec. 15, 2000

Related U.S. Application Data
(60) Provisional application No. 60/232,875, filed on Sep. 15, 2000.

(51) Int. Cl. H04M 1/64; H04M 11/00

(52) U.S. Cl. 379/67.1; 379/88.13; 379/88.17

(57) ABSTRACT

The present invention is a system that includes a handheld wireless computer, such as a PDA, through which a user can select a voice message to be played to the user from an inventory of messages. The inventory is presented within a displayed page on the computer. The computer is also used to designated a telephone number of a telephone which is to be called and through which the message is to be played when the telephone is answered via a displayed page that includes a description of the selected message and includes a field for entering a telephone number. A message system retrieves the designated voice message, telephones the designated telephone and plays the message through the telephone when the telephone is answered.

### CROSS REFERENCE TO RELATED APPLICATION

This application is related to and claims priority to U.S. provisional application entitled “Using A Personal Digital Assistant To Redirect A Voice Message To A Telephone” having Ser. No. 60/232,875 by Ayres et al, filed Sep. 15, 2000 and incorporated by reference herein.

### BACKGROUND OF THE INVENTION

1. Field of the Invention

The present invention is directed to system that allows a wireless handheld computer to designate a voice message to be played through a telephone where a message system plays the voice message through the telephone and, more particularly, to a system that provides a user a message inventory on request, allows the user to select a message from the inventory and designate a telephone through which to play the message, and then telephones the designated telephone and plays the selected message through the telephone when the telephone is answered.

2. Description of the Related Art

A Personal Digital Assistant (or PDA) is a small mobile handheld device or hand-held computer providing computing, storage and retrieval capabilities for personal or business use. PDA's are often used for maintaining a calendar and managing address books as well other tasks such as sending and retrieving e-mail when equipped for wireless Internet access.

A PDA can also be used to display message inventories. Using a PDA and a wireless modem or a PDA capable of directly providing wireless capabilities (such as the Palm Pilot VII), the user can connect to a server and request message inventory information. The server aggregates the user's e-mail and voice messages and sends the information back to the PDA.

The user can then select a message to display. If the user selects an e-mail message, the PDA requests the body of the message from the server. When the body is received from the server, it is displayed on the PDA. If, however, the user selects a voice message the voice recording cannot be played due to the limited hardware capability of the PDA.

There are two problems in using a PDA to retrieve a voice message. The major problem is simply the limited hardware capabilities of the device. The current PDA market leader is PALM PILOT PDA device by Palm, Inc. of Santa Clara, Calif. PALM devices are not equipped with a sound hardware capable of playing voice.

What is needed is a system which will allow a PDA to play a voice message.

A lesser problem is the large size of digital voice messages. Downloading a voice message from the server to the PDA is expensive. Current PALM VII wireless plans charge on a per byte basis.

What is needed is a system which will allow a PDA to download a voice message for playing.

### SUMMARY OF THE INVENTION

It is an aspect of the present invention to allow a user to play a voice message using a PDA.

It is another aspect of the present invention to allow a user to direct the playing of a voice message through a specified telephone.

It is also an aspect of the present invention to allow a user to designate a telephone through which a selected voice message is to be played.

The above objects can be attained by a system that includes a hand held wireless computer through which a user can select a voice message to be played to the user from an inventory of messages. The computer is also used to designate a telephone number of a telephone which is to be called and through which the message is to be played when the telephone is answered. A message system retrieves the designated voice message, telephones the designated telephone and plays the message through the telephone when the telephone is answered.

These together with other objects and advantages which will be subsequently apparent, reside in the details of construction and operation as more filly hereinafter described and claimed, reference being had to the accompanying drawings forming a part hereof, wherein like numerals refer to like parts throughout.

### BRIEF DESCRIPTION OF THE DRAWINGS

FIG. 1 depicts hardware and software components of the present invention.

FIG. 2 shows the operations performed by the system.

FIGS. 3, 5, 6, 8 and 10 depict the operations in more detail.

FIGS. 4, 7 and 9 illustrate interface screen displays of the present invention.

### DESCRIPTION OF THE PREFERRED EMBODIMENTS

The present invention allows a user to designate a message for playing using a conventional wireless PDA. Instead of downloading the voice message and attempting to play it using the PDA (which is currently impossible on most devices), the user can direct the voice message to a nearby telephone. After selecting the voice message from an inventory list, the user is given the option of specifying a telephone number and sending the message to the telephone. For example, while using the PDA, the user wirelessly connects to a message server to retrieve an inventory of current e-mail (electronic mail) and voice mail messages. When reviewing the voice messages, the user notices there is an urgent voice message he has been expecting. The user then enters the number of a nearby telephone and requests that the message be sent to the nearby telephone. The telephone then rings and the user answers the telephone and listens to the message.

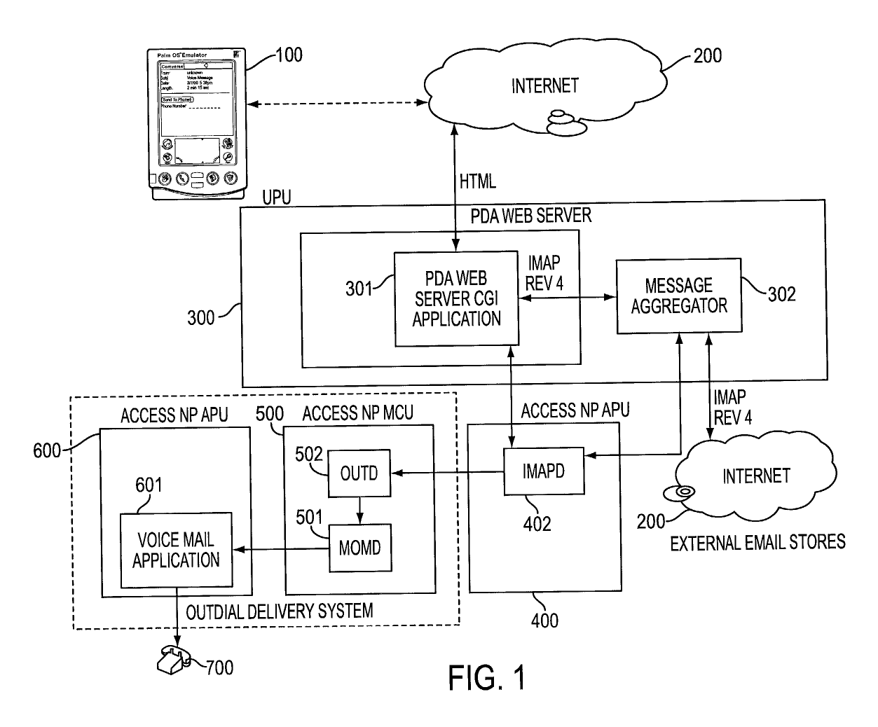

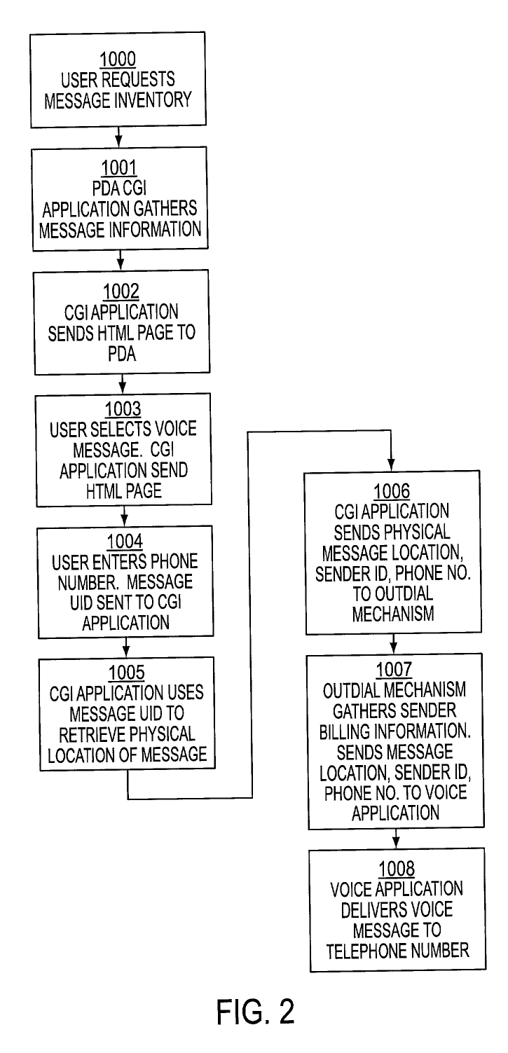

As depicted in FIGS. 1 and 2, the user, after conventionally logging-in to the system via the wireless PDA 100, requests 1000, using HTTP over a packet switched network 200, such as the Internet, a list (or inventory) of messages in their mailbox. The user's request specifies the address of a web server 300 and identifies the Common Gateway Interface (CGI)/Application Service Provider (ASP) application 301 that is invoked (and also includes any needed session identifier).

The PDA CGI Application 301 uses a conventional Message Aggregator 302 to collect 1001 information about the user's e-mail and voice mail. To collect voice mail information, the Aggregator 302 communicates with an Internet Message Access Protocol (IMAP) server 402 running on a message system, such as the Access NP (ANP) system available from Comverse Network Systems of Boston, Mass.

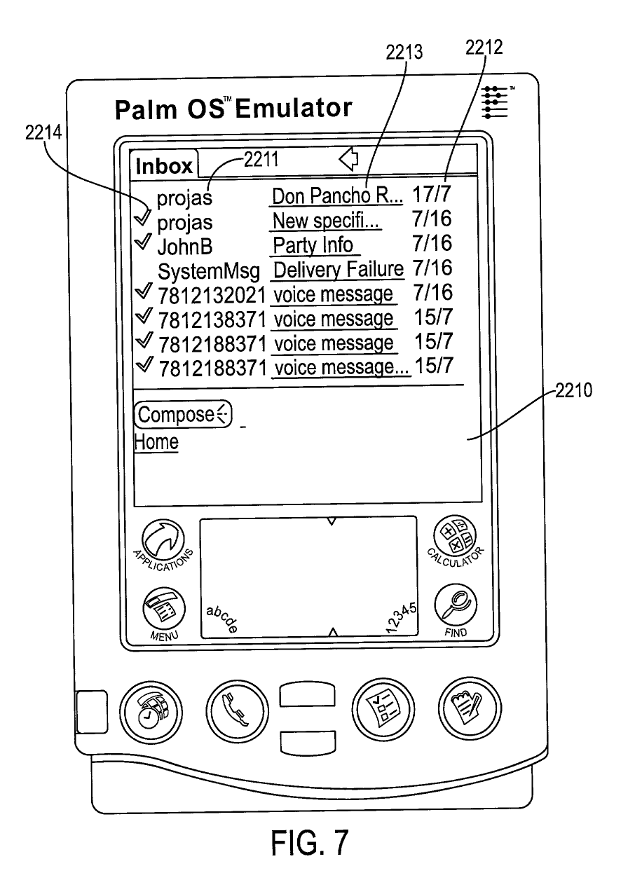

Using the information provided by the Aggregator 302, the PDA CGI program 301 communicates 1002 a message inventory interface page (see FIG. 7) in HTML back to the PDA 100.

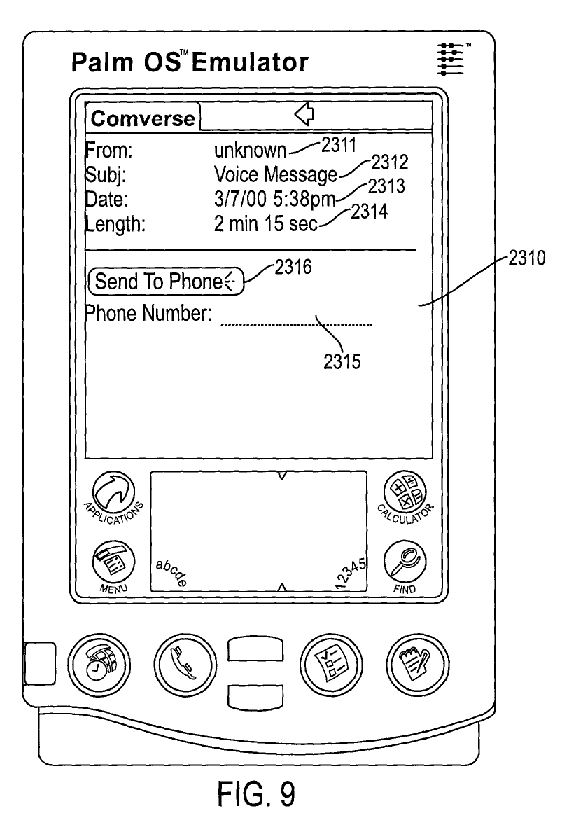

In a similar manner, the user selects 1003 a voice message to display and the PDA CGI application provides an HTML interface page display of information about the voice message (see FIG. 9). Included in the voice message information is the IMAP4Rev1 UID (Unique Identifier), which is an identifier which uniquely identifies this message in the mailbox.

Using the PDA Web interface, the user enters 1004 a telephone number into a field in the interface and requests that the message be sent to the telephone by activating a “send” control. The PDA 100 passes, using HTTP, the telephone number, subscriber ID, and message UID to the PDA CGI application 301.

The CGI application 301 uses the message UID to communicate with an IMAP server 402 which is a process/module available within the ANP, through the Message Aggregator 302, to identify 1005 the physical location or file name location (logical location) in storage, such as disk storage, where the voice message exists or is stored. Once the physical location is identified, the CGI application 301 passes the physical location information to the IMAP server 402 requesting that a voice message be sent to the specific telephone having the telephone number. The request command passes the subscriber's (sender's) ID, the message location on disk of the message, and the telephone number of the telephone that should receive the message. This communication is accomplished using an extension to the IMAP Rev 4 Protocol discussed later herein.

The IMAP server 402 sends 1006 the request and associated information to an Outdial Daemon 502 running on a Master Control Unit 500 using UDP (User Datagram Protocol).

The Outdial Daemon 502 in turn communicates with a Momd Process 501, which ultimately chooses a channel and chooses 1007 a running Voice Mail application 601 to perform the voice message delivery.

The Voice Mail application 601 determines the billing information for the call by looking up information stored in the subscribers account, and then dials or telephones the requested telephone number. If the telephone 700 is answered, the Voice Mail application 601 then plays 1008 the message. If the telephone is not answered, the number will be re-dialed periodically for a number of times or until a successful connection is made responsive to redial information in the profile. The Outdial Daemon, Momd, Master Control Unit and Voice Mail application are processes/modules available within the ANP.

The sequence discussed above can be broken down into a number of operations including the user requesting an inventory, the PDA CGI Application gathering message information, the CGI Application sending an HTML page to the PDA, the user selecting a voice message to play, the user entering a telephone number which, along with the Message ID is sent to the CGI Application, the CGI Application using the Message ID to retrieve the physical location of the message, and the voice message being delivered to the specified telephone. These operations will now be discussed in more detail.

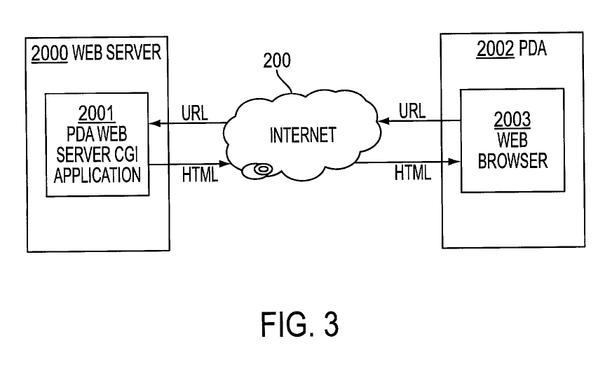

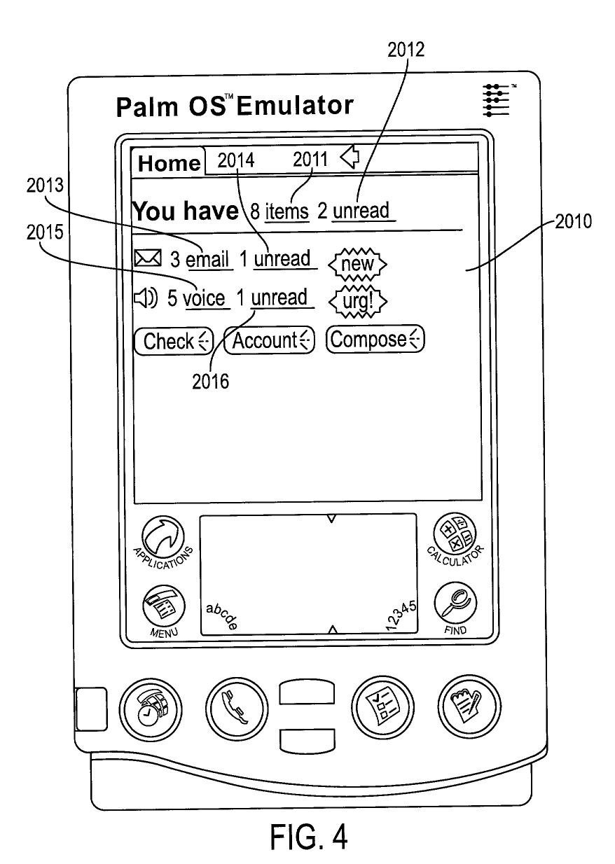

In requesting the inventory, the PDA 2002 (see FIG. 3) runs any commercially available web browser. After the log-in, the web browser 2003 presents an HTML page summarizing pending messages that has been previously passed from the server 2000 to the browser 2003. For example, after the user has logged into the server, an HTML page 2010 summarizing pending messages as depicted in FIG. 4 is presented to the user. This page 2010 shows URL (Universal Resource Locator) tagged fields or controls for a total list of message items 2011, those that are unread 2012, all of the e-mail messages 2013, the unread e-mail messages 2014, all of the voice mail messages 2015 and the unread (unplayed) voice mail messages 2016. The display also includes icons for new, messages, urgent messages, etc. Assuming that the user wants to review all of the message inventory, when the user clicks on the “8 items” control, a URL request is, along with the session identifier, password, etc., passed from the browser 2003 running on the PDA to the server 2001. The request identifies the command identifier (ID), which in this case is the inventory command, and the user ID.

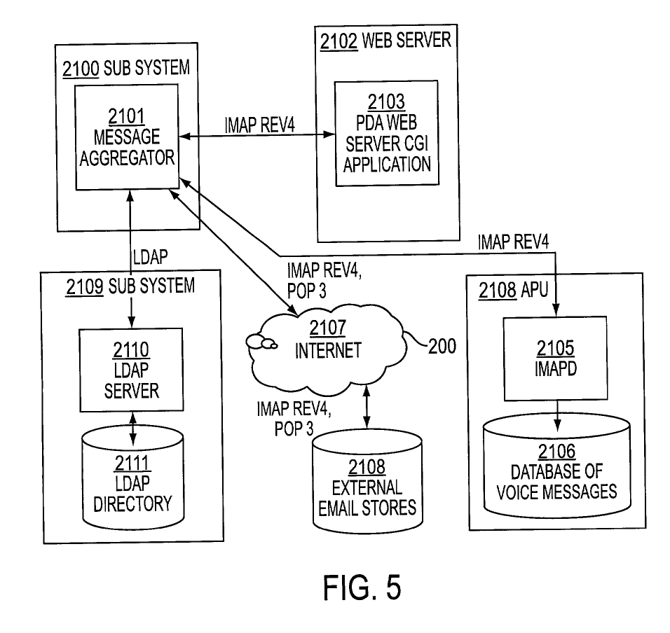

In gathering the message information, when the CGI Application 2103 (see FIG. 5) receives the request for the inventory, the user is identified in the URL request. The CGI Application 2103 takes the user ID and authenticates the user using the current practice of the art. The CGI Application 2013 communicates with the Message Aggregator 2101 using the IMAP4 REV 1, Internet Message Access Protocol 4 Revision 1. Using the protocol, the user ID and password are then passed to the Message Aggregator 2101 and the message inventory is requested.

The Message Aggregator 2101, also known as the UMSI (Unified Message Store Interface) is a software daemon that runs either on the web server platform or another local networked subsystem. The Aggregator 2101 is a software process/module of the ANP.

The Message Aggregator 2101 uses a conventional LDAP (Lightweight Directory Access Protocol) to communicate to a conventional LDAP server 2109. Using a privileged user ID and password, the Message Aggregator 2101 binds to the LDAP server 2109 and issues LDAP requests to retrieve user profile information from an LDAP database 2111. In this fashion, the Message Aggregator 2101 obtains the information needed to retrieve e-mail for the user. This information includes: 1. the address of an external e-mail server, 2. the e-mail server user ID, and 3. the e-mail server password. Using this information, the Message Aggregator 2101 communicates over the network 200 to external e-mail stores 2108 to obtain the user's e-mail messages. Two standard protocols are used to retrieve the messages: Post Office Protocol 3 (POP3), and the Internet Message Access Protocol 4 Rev 1 (IMAP4).

The Message Aggregator 2101 also obtains the voice messages of the user. The voice messages are stored locally in the ANP system. To get the voice messages, the Message Aggregator 2101 communicates to an IMAP daemon 2105 using the IMAP4Rev 1 protocol which obtains and returns information identifying the voice mail messages.

Having obtained both the e-mail and voice messages, the Message Aggregator 2101 can then return the requested information to the CGI Application.

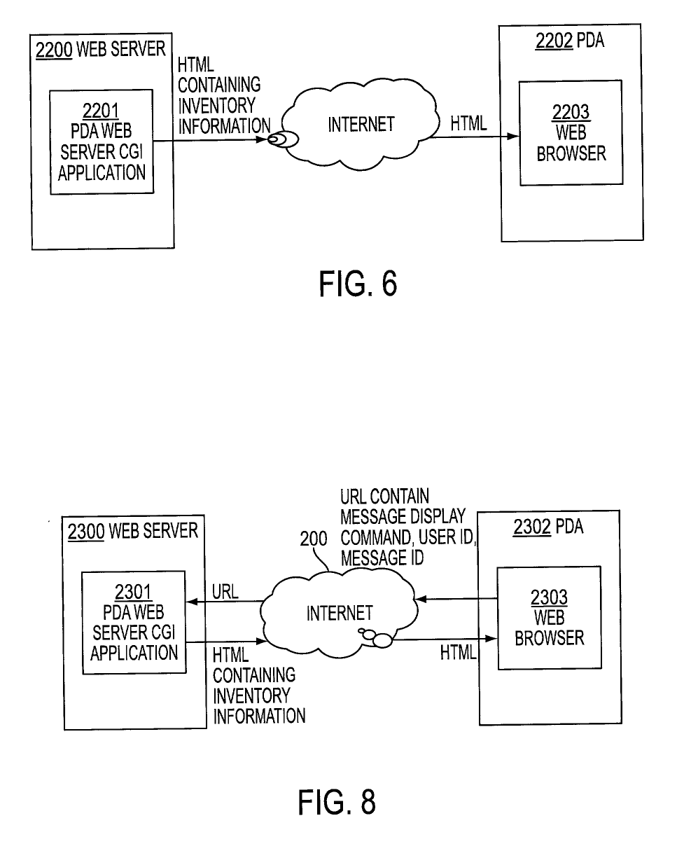

When the CGI Application 2201 is to send an HTML Page to PDA, having obtained the inventory information, the CGI Application 2201 (see FIG. 6) constructs a corresponding HTML inventory interface page 2210 as depicted in FIG. 7. The HTML page is then passed back to the PDA device 2201. The HTML page is received by the browser 2203 and displayed on the PDA display screen.

The inventory page 2210 includes a field 2211 for identifying the source of the message, a date field 2212 and a URL tagged message type or subject field or control 2213. The page 2210 also includes a status field 2214 indicating the status of the message such as the “check mark” indicating the message has been reviewed.

FIG. 7 also shows controls for additional functions. The compose function allows a user to compose a voice message that can be sent as a response to any of the messages in the inventory. If the original message is a text message, the response is converted into a voice message using a text to speech converter and can be played through the telephone of the original message sender. If the original is a text e-mail message, the response is converted into an e-mail message. The compose function also allows the user to select from among a number of precomposed replies, such as “I am out of the office and will respond when I return” which can be played to the original voice message sender.

The HTML page 2210 is constructed using conventional techniques such that when the user clicks on the word “voice message” included in the control 2213, a URL request is created and made to the server 2202. The URL request is formed containing: 1. a command identifier which in this case is a “display message” command, 2. the user ID, and 3. the Unique Message ID (UID). The Unique Message ID is obtained from the Message Aggregator 2101. The message ID is part of the IMAP4 REV1 protocol. The message ID is a character string that uniquely identifies a message in a user mailbox.

When the user selects a voice message to display, the URL request contains: the command identifier, the user ID, and the Unique Message ID. The CGI Application program 2301 (see FIG. 8) receives this information, along with the session identifier, etc., and again communicates with the Message Aggregator 2101 using the IMAP4 REV1 Protocol. Using this protocol, the CGI Application 2301 obtains the information necessary to construct an HTML interface page 2310 describing the message as depicted in FIG. 9. This information contains fields for the sender 2311 of the voice message, if known, the subject or message type 2312, the date and time 2313 the message was received and the length 2314 in seconds of the message.

The selected message description HTML interface or message presentation page 2310 also contains a field 2315 into which the user can enter a telephone number where the message should be sent and a “Send” button or control 2316. The HTML page 2310 is then passed from the CGI Application to the Web Browser 2303. The Web Browser 2303 then displays the page 2310 on the PDA device 2302.

The PDA is now displaying message information about a particular voice message. Using the web browser running on the PDA, the user enters the telephone number in field 2315 and clicks the “Send” button 2316. Clicking the button 2316 causes a URL request to be created and sent to the CGI Application along with the session identifier, etc. The URL request contains: 1. a command identifier for a command to send the message to a telephone, 2. the user ID, 3. the Message ID (UID) and 4. the telephone number.

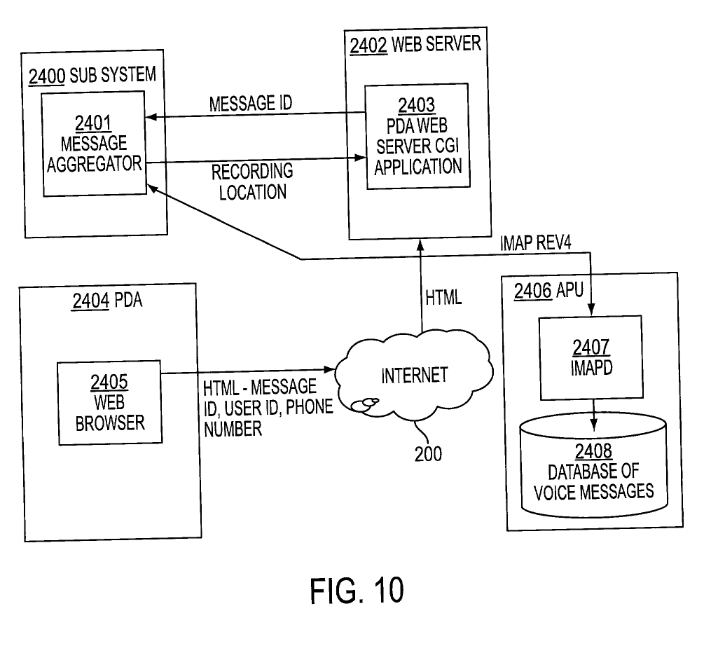

As shown in FIG. 10, the CGI Application 2403 receives the URL request from the PDA 2404. The CGI Application 2403 then communicates with the Message Aggregator 2401, using the IMAP4 REV1 Protocol. Using the protocol, the CGI Application 2403 requests the message header for the given message ID. The Message Aggregator 2401, in turn, communicates using IMAP4 REV1, to IMAPD 2407 requesting the message header. In response, IMAPD 2407 forms a message header. However, rather than containing the voice recording, the message header instead contains the path to where the voice data resides. The IMAPD 2407 obtains the location of the voice recording by accessing the database 2408 that stores a record of the user's voice messages. This message header, containing the physical location of the voice recording, is passed back to the Message Aggregator 2401, which in turn passes the physical location back to the CGI Application 2403.

Once the CGI Application 2403 has received the message body, containing the physical location of the recorded data, the Application 2403 communicates a new request to IMAPD 2407. This request is a custom extension of the IMAP4 REV1 protocol that provides information for sending a voice message to a telephone.

Although it is not part of the IMAP4 REV1 protocol, IMAPD 2407 which is part of an ANP was constructed to understand a “DEPOSIT” command. The form of this command is described below.

DEPOSIT (<recipient>){<size>}

<message body>

DEPOSIT is the command identifier. The recipient field includes an optional prefix, indicating delivery instructions, followed by a telephone number or address:

<recipient>=<prefix><telephone no>

<prefix>=“fax=”∥“voice=”

### EXAMPLES

voice=9782245001

fax=9782245002

The meaning of the prefix field is defined in the table below

Prefix Meaning

fax Deliver the given fax message by out dialing the given recipient telephone number

voice Deliver the given voice message by out dialing the given recipient telephone number

The message body contains the user ID of the sender of the voice message, and the location of the voice recording file. In the example below, 9782245000 identifies the sender of the message while \\dg_v02\1data\bostech\PO4\00\00\04\07) identifies the location of the file.

MIME-Version: 1.0

From: allan <9782245000@anywhere>

Subject: one-voice-attachment

Content-Type: message/external-body; access-type=cifs;

name=“\\dg_v02\\1data\bostech\PO4\00\00\04\07”; size=8975

Content-type: Audio/x-CNSW

Content-Disposition: inline; voice=Voice-Message;

filename=Voice.OKI

Content-Description: The voice message

Content-Duration: 4

Content-ID: 1

The size field contains the number of bytes in the message body.

In the delivery of the voice message, IMAPD 2407 (also 402 of FIG. 1) receives the DEPOSIT command from the CGI Application 2403. The command contains: 1. the physical location of the voice message recording, 2. the telephone number to which the recording should be sent, and 3. the user ID of the sender of the voice message. The information is sent from IMAPD to the outdial mechanism (see 502 of FIG. 1) previously discussed using the User Datagram Protocol (UDP). The outdial mechanism, which is an existing feature of the ANP system, parses the message to obtain the location, telephone number and user ID and plays the voice message to the telephone number and when appropriate doing so after a password is entered at the telephone. A discussion of this mechanism was previously described herein.

When the message is delivered or the delivery fails, the system can supply a status message to the PDA indicating success or failure. FIG. 7 depicts a display showing a delivery failure. A similar message indicating success can also be displayed.

The method described above to send a voice message from the PDA to a telephone can be applied to fax messages as well. The differences between the voice and fax delivery can be summarized as follows:

With fax messages, the file containing the message contains a image in TIFF format rather than a voice recording.

The fax message is sent to the telephone using the same existing outdial mechanism previously discussed. The telephone number is associated with a fax machine which then prints the image.

Using the a similar approach as for voice messages, sound recordings attached as part of e-mail (electronic mail) messages can be sent to the telephone. Using the IMAP or POP3 protocol, the Message Aggregator obtains the data of the recording and stores the data locally in a file. The CGI Application then refers to this local file when making a request to IMAPD to deliver it to a telephone.

Also using a similar approach, an e-mail message can be converted to speech and sent to a telephone. Using the IMAP or POP3 protocol, the Message Aggregator obtains the text of the e-mail message. Using commercially available text to speech converters, the text of the message is converted into a sound file containing the spoken text. The CGI Application then refers to this local file when making a request to IMAPD to deliver it to a telephone.

An e-mail can be converted into a facsimile message and sent to a facsimile capable telephone system.

The system of the present invention also includes permanent or removable storage, such as magnetic and optical discs, RAM, ROM, etc. on which the process and data structures of the present invention can be stored and distributed. The processes can also be distributed via, for example, downloading over a network such as the Internet.

The present invention has been described with respect to sending the voice message to a single telephone. It is also possible to send the message to multiple telephones using a group list distribution operation available in message systems such as the ANP. The present invention can also allow the user to create a text message (such as in an e-mail) and send the text message to a telephone using text to speech conversion. The audio portion of an audio/video message can also be sent to a specified telephone.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus, comprising:
a handheld computer designating a message to be played through a telephone; and
a message system playing the message through the telephone.

2. An apparatus as recited in claim 1, wherein the message comprises a voice message.

3. An apparatus as recited in claim 1, wherein the telephone comprises a facsimile capable system and the message comprises a facsimile message.

4. An apparatus as recited in claim 1, wherein the message comprises an e-mail message converted into a voice message.

5. An apparatus as recited in claim 1, wherein the message comprises a voice message attached to an e-mail message.

6. An apparatus as recited in claim 1, wherein the computer communicates to the message system wirelessly.

7. An apparatus as recited in claim 1, wherein the computer communicates to the message system wirelessly and over a packet switched network.

8. An apparatus as recited in claim 1, further comprising a server obtaining an inventory of messages from the message system responsive to a user request entered in the computer and providing the inventory to the computer.

9. An apparatus as recited in claim 1, wherein the inventory comprises voice, e-mail and facsimile messages.

10. An apparatus as recited in claim 1, further comprising a server providing a display to the computer comprising a telephone number entry field and a send control to the computer for a designated voice message.

11. An apparatus as recited in claim 1, further comprising a server obtaining a location of a designated message and providing the location to the message system.

12. An apparatus as recited in claim 1, wherein the message system dials a telephone number of the telephone and plays the message through the telephone when the telephone is answered.

13. A voice message system, comprising:
a telephone having a telephone number;
a handheld computer having an interface allowing a user to request and displaying an inventory of voice messages, and allowing a user to produce a designation for one of the voice messages to be played through the telephone comprising the telephone number;
a wireless communication facility coupled to said handheld computer;
a telephone network coupled to said telephone; and
a storage and message play system coupled to said wireless communication facility and said telephone network, producing the inventory responsive to the request and sending the inventory to said computer via said facility for display thereon, calling said telephone number over the network responsive to the designation received from said computer via said facility and playing the message through said telephone, and comprising:
an inventory server obtaining the inventory of messages responsive to the user request entered in said computer and providing the inventory to said computer where the inventory comprises voice, e-mail and facsimile messages;
an interface server providing a display to the computer comprising a telephone number entry field and a send control for designating the message; and
a location server obtaining a location of the message; and
a message play server dialing the telephone number of the telephone, obtaining the message from the location and playing the message through the telephone when the telephone is answered.

14. A process, comprising:
designating a voice message to be played through a telephone using a hand held computer; and
playing the voice message through the telephone.

15. A computer readable storage controlling a computer by designating a voice message to be played through a telephone using a hand held computer, and playing the voice message through the telephone.

16. A handheld computer interface comprising information identifying a voice message, a send control for the voice message and an area for entering a telephone number of a telephone through which the voice message is to be played when the send control is activated.

17. A message system command comprising a telephone number to which a voice message is to be sent when the command is initiated via a handheld computer and a storage location of the voice mail message.
